(19) United States
(12) Patent Application Publication
(10) Pub. No.: US 2018/0129985 A1
(43) Pub. Date: May 10, 2018

(54) TIME WINDOW SELECTION FOR VEHICLE ROUTING PROBLEM

(71) Applicant: International Business Machines Corporation, Armonk, NY (US)

(72) Inventors: Michael Katz, Nahariya (IL); Vladimir Lipets, Haifa (IL); Michael Masin, Haifa (IL); Dany Moshkovich, Yokneam Ilit (IL); Segev E. Wasserkrug, Haifa (IL)

(21) Appl. No.: 15/344,595

(22) Filed: Nov. 7, 2016

(51) Int. Cl. G06Q 10/04; G06Q 10/10

(52) U.S. Cl. CPC G06Q 10/047; G06Q 10/109

(57) ABSTRACT

A computer-implemented method, computerized apparatus and computer program product for selecting time windows to vehicle routing problems. A set of criteria for estimating desirability of scheduling an appointment to a time interval, and a set of time intervals at which appointments can be scheduled are obtained. A new appointment for scheduling to a time interval is received. For each time interval of the set, a balanced score according to the set of criteria is calculated. A time interval for scheduling the new appointment is selected based on the balanced score.

### TECHNICAL FIELD

The present disclosure relates to combinatorial optimization in general, and to optimizing vehicle routing with time windows problems, in particular.

### BACKGROUND

The Vehicle Routing Problem (VRP) is a combinatorial optimization problem attracting an ongoing interest and extensive studying from both theoretical and practical perspectives. The VRP is concerned with finding an optimal set of routes to be used by a fleet of vehicles for serving a set of customers, e.g. delivering goods to them. There are many variants of the VRP, such as the Capacitated VRP (CVRP), in which the vehicles have limited carrying capacity of the goods that need to be delivered, the VRP with Time Windows (VRPTW), where the customers have specified time intervals during which they need to be served, so that the schedule of the vehicle trips needs to be determined, and the like.

Mobile workforce scheduling problems can be seen as variation of the VRPTW. Mobile workforce scheduling is a task of assigning mobile agents to perform tasks, often at remote locations, during designated time frames. For example, in case of a telecommunications company having a pool of technicians, and a set of service calls to be handled, the scheduling problem may include the selection of which service calls, and at what order, each technician would attend to.

Recently there is great attention directed at more complex variants of the VRP, also referred to as “rich” VRPs, which may be closer to practical distribution problems than the basic VRP models. Examples of “rich” VRPs include heterogeneous fleets, e.g. technicians with multiple and/or leveled skills, multiple depots at which service routes start and end, different types of services to be performed, and so forth. Due to both the diversity and complexity of the “rich” VRPs, no universal heuristic solution that accommodates all possible cases, and is applicable in real time, can exist.

Another area in which efforts are invested is the dynamic VRP, where changes of certain kind that affect the problem are assumed to occur while an attempt to solve it is taking place. For example, such changes may involve vehicle breakdown, traffic jams, new order placements, withdrawal of orders, or the like. The solutions proposed so far to the dynamic VRP suffer from major drawbacks and limitations, such as reliance on some assumption about service distribution probabilities and/or significantly long computation time, i.e. cannot be carried out in real time.

### BRIEF SUMMARY

One exemplary embodiment of the disclosed subject matter is a computer-implemented method comprising: obtaining a set of criteria for estimating desirability of scheduling an appointment to a time interval; obtaining a set of time intervals at which appointments can be scheduled; receiving a new appointment for scheduling to a time interval; calculating, for each time interval of the set, a balanced score according to the set of criteria; and selecting, based on the balanced score, a time interval for scheduling the new appointment.

Another exemplary embodiment of the disclosed subject matter is a computerized apparatus having a processor, the processor being adapted to perform the steps of: obtaining a set of criteria for estimating desirability of scheduling an appointment to a time interval; obtaining a set of time intervals at which appointments can be scheduled; receiving a new appointment for scheduling to a time interval; calculating, for each time interval of the set, a balanced score according to the set of criteria; and selecting, based on the balanced score, a time interval for scheduling the new appointment.

Yet another exemplary embodiment of the disclosed subject matter is a computer program product comprising a non-transitory computer readable storage medium retaining program instructions, which program instructions when read by a processor, cause the processor to perform a method comprising: obtaining a set of criteria for estimating desirability of scheduling an appointment to a time interval; obtaining a set of time intervals at which appointments can be scheduled; receiving a new appointment for scheduling to a time interval; calculating, for each time interval of the set, a balanced score according to the set of criteria; and selecting, based on the balanced score, a time interval for scheduling the new appointment.

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

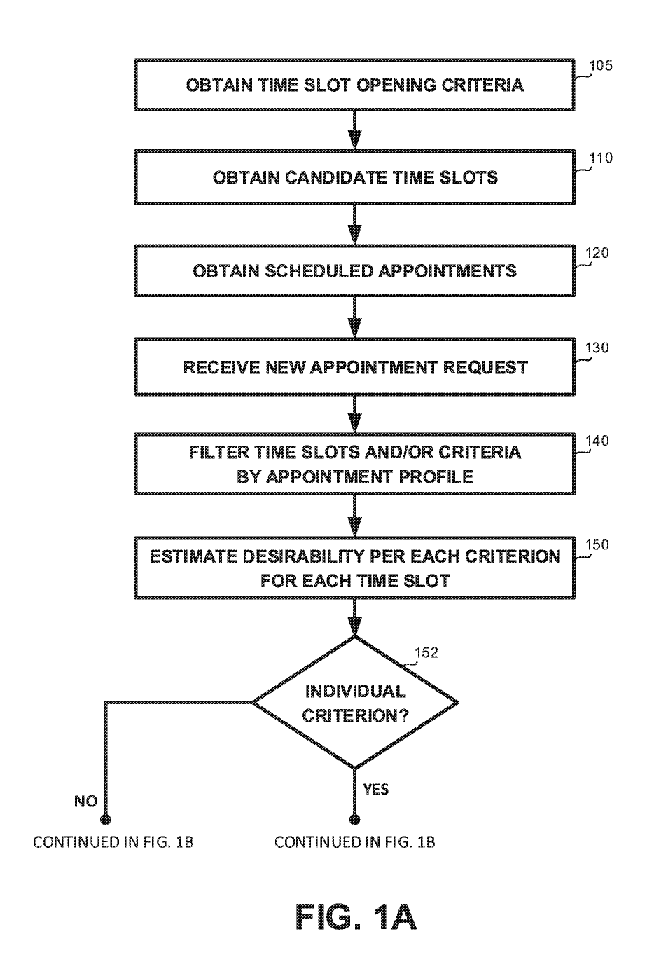

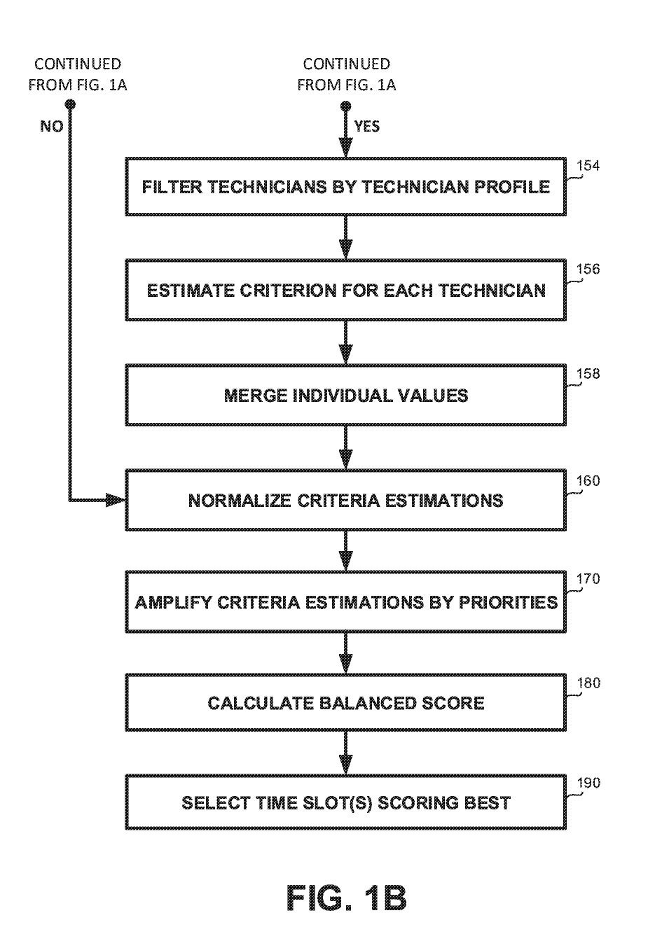

FIGS. 1A-1B show a flowchart diagram of a method, in accordance with some exemplary embodiments of the disclosed subject matter; and

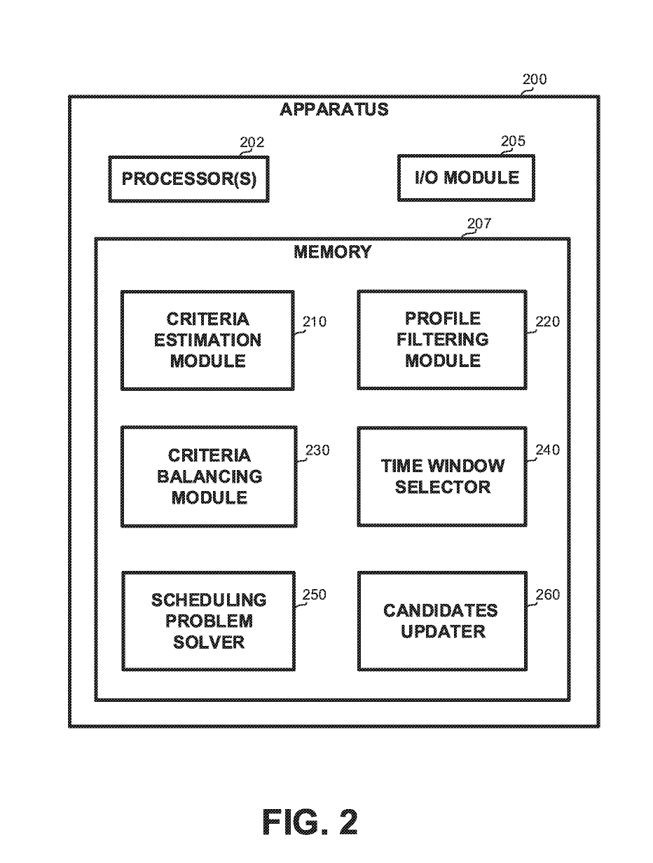

FIG. 2 shows a block diagram of an apparatus, in accordance with some exemplary embodiments of the disclosed subject matter.

### DETAILED DESCRIPTION

One technical problem dealt with by the disclosed subject matter is to select a time window for a route trip by a vehicle in an instance of a vehicle routing problem with time windows (VRPTW) according to one or more predetermined criteria. In a typical situation arising in real life applications, a provider may be required to respond to a customer requesting service at a given location, where a time frame for delivery may have to be coordinated. Within a short time, such as during a phone conversation with the customer in which the service request is made, the provider may propose several optional time windows, also referred to as time slots or time intervals, for the customer to consider and choose from.

It will be appreciated that as opposed to conventional VRPTW settings, where time windows for servicing customers are given as part of the definition of the problem, the disclosed subject matter is concerned with deciding on which time slots out of a collection of available openings would be offered to a customer, whereby one of these options is eventually assigned for delivering the service. As can be readily understood, the time window assignment for each of the service requests may significantly affect the solution space for the instance of VRPTW thus obtained, namely, the collection of possible routes or schedules of vehicle trips. Assigning the time windows to the tasks may thus have great impact on the efficiency of the solution, sometime even more than selecting the routing solution.

The proposed time windows options may be required to comply with certain rules, policies, regulations, or the like, aimed at achieving sought for objectives or effects, such as, for example, prioritizing some customers or segments thereof, enforcing a time or distance limit between new and previously opened slots, balancing workloads among technicians, or the like. Additionally or alternatively, these options may be subject to optimization criteria or goals, such as, for example, reducing the number of route trips required to service all customers, shortening the total travel distance and/or time, or the like. In some exemplary embodiments, different regions in which services are provided may call for different policies of slot opening to be applied with respect to each of them. For example, time windows selection based on historic data may perform better in areas of high population concentrations than in sparsely populated regions with large travel distances between locations. A slot opening decision may be required to tradeoff between multiple factors, as well as accommodate various aspects of “rich” VRPs, including, for example, multiple zones, multiple skills or skill levels, distinction between mandatory and optional tasks (e.g., intervention as opposed to maintenance), or the like. Often the decision may be required to be made in real time.

One technical solution is to estimate for each of the available time intervals a desirability level of scheduling thereto a new appointment received, according to one or more predefined criteria, and calculate a balanced score for each time interval based on the criteria estimations. Time window options for scheduling the new appointment may then be selected based on the calculation results, e.g. the ones for which the balanced scores are the highest.

In some exemplary embodiments, the balanced score may be calculated by aggregating the plurality of criteria estimations in accordance with a predetermined scheme, such as, for example, summation, multiplication, or the like. In some further exemplary embodiments, the contribution of each of the aggregated estimations to the balanced score may be amplified based on priority weights specified for the various criteria. The estimations may be subject to a normalization operation prior to aggregation.

In some exemplary embodiments, one or more criteria estimations may be based on parameters of appointments already scheduled to the time intervals being considered. These parameters may include, for example, location, expected duration, skills required from a technician handling the task, or the like. In some further exemplary embodiments, an estimation may be based on parameters of the new appointment, either in addition to or in lieu of the parameters of scheduled appointments. In some further exemplary embodiments, the estimation may be based on additional information or settings, such as historic data, base location (i.e., where a route starts and ends), or the like.

In some exemplary embodiments, one or more of the predefined criteria may be indicated as personal criteria to be applied for each technician in the workforce individually. A consolidated estimation for such individual criterion may be calculated by merging individual values calculated for the whole group of technicians in accordance with a predetermined scheme. Individual criteria estimations may be based on parameters of newly and/or previously received appointments, similarly as for regular criteria. Additionally or alternatively, individual criteria estimations may be based on individual parameters of technicians, such as associated depot locations, skill levels, or the like. In some exemplary embodiments, an individual criterion may depend on a particular assignment of scheduled appointments to the technicians. For example, the criterion may be estimated individually for each technician based on parameters of scheduled appointments, with restriction to those appointments that have been assigned to the technician in question.

In some exemplary embodiments, an appointment profile may be defined for filtering either one or more criteria, time intervals, or both. For example, in case of criteria filtering, an estimation of a specified criterion may be performed selectively, i.e. if a new appointment for which a time window needs to be selected does not fit the profile, the criterion may not be applied in the calculation of the balanced scores, thus excluding its contribution thereto. Additionally or alternatively, certain time periods, time slots within those periods and/or time slots types may be specified, such that a time interval that does not fit the profile may be skipped. An appointment profile may include factors such as the appointment duration, required skills, location, or the like.

In some exemplary embodiments, a technician profile may be defined for filtering one or more individual criteria. An estimation of an individual criterion may be performed selectively based on whether or not a technician fits the profile. For example, the criterion may not be applied for technicians which do not fit the profile, such that individual values of those technicians are excluded from the calculation.

In some exemplary embodiments, the set of available time intervals may be defined with respect to a given time horizon, i.e. a maximal length of time period ahead of the current time along which time slots may be opened. The set of available slots may be updated based on the time horizon parameter, either periodically or on demand. For example, a time horizon may be of several days long, e.g. 3, 5, 7 days or the like. Time slots may be defined with respect to predetermined periods in a day, e.g. morning, noon, evening, or the like, or with respect to technicians' shifts, e.g. first shift, second shift, third shift, or the like. Each period or shift may comprise one or more slots, e.g. slots 11:00-12:30, 13:00-15:00 and 16:00-17:00 on the noon shift, or the like.

One technical effect of utilizing the disclosed subject matter is to allow for robust slot opening decision making in the context of VRPTW in real time.

Another technical effect of utilizing the disclosed subject matter is to provide a framework for defining and enforcing a comprehensive, multi-faceted policy for slot opening in instances of VRPTW, e.g. mobile workforce scheduling problems. The framework may fit any configuration of a “rich” VRP, e.g. multiple zones, multiple and/or levelled skills, or the like.

In some exemplary embodiments, a business user or domain expert, such as, for example, an enterprise architect, a compliance officer, or the like, may define multiple rules and criteria, optionally with priorities. The rules and criteria may be defined offline. During run-time, real time analysis of all defined criteria may be applied and an optimal decision may be made instantly. The mixing of multiple criteria in accordance with the disclosed subject matter allows a domain expert to easily achieve an expected configuration, while optimizing time window selection based on these criteria. In some exemplary embodiments, historical information may be available and/or collected and suggestions about optimal configuration may be presented to the domain expert. The time window selection in accordance with the disclosed subject matter may allow for achieving an overall solution to the scheduling problem that is more efficient than would otherwise be obtained, e.g. by reducing expected total travel time or the like.

Referring now to FIGS. 1A-1B showing a flowchart diagram of a method, in accordance with some exemplary embodiments of the subject matter.

On Step 105, a set of criteria for estimating desirability of scheduling an appointment to a time interval may be obtained, optionally along with assigned priorities. The set of criteria and/or priorities may be defined by a domain expert. In some exemplary embodiments, the criteria may be defined using predefined algorithmic measures. The algorithmic measures may comprise calculations of spatiotemporal properties or relations of existing and new appointments, depot locations, or the like. For example, a criterion of closeness between scheduled appointments, aimed to enforce selection of time slots during which there are appointments in locations close to the location of a new appointment, may entail calculation of distances between locations of each of the previously scheduled appointments and the new appointment. In some exemplary embodiments, one or more criteria may be indicated as individual criteria, required to be applied individually for each of the technicians.

On Step 110, a set of time intervals at which appointments can be scheduled, i.e. candidate available time slots, may be obtained. In some exemplary embodiments, the available time slots may be determined in accordance with a given time horizon parameter.

On Step 120, a set of appointments scheduled to time intervals of the set obtained in Step 110, may be obtained. An appointment may be defined as a tuple of parameters, such as location, duration, skills required, or the like. It will be appreciated that each time interval may comprise either zero, one, or multiple appointments scheduled thereto.

On Step 130, a request for scheduling a new appointment to a time interval may be received.

On Step 140, the set of criteria obtained in Step 105 and/or the set of time intervals obtained in Step 110 may be filtered based on the new appointment received on Step 130 fitting an appointment profile. The appointment profile may be associated with a specific criterion, e.g. as part of its definition, in which case filtration of time intervals may be restricted to calculation of that criterion only, or employed globally for the entirety of the criteria set.

On Step 150, for each time interval in the set obtained in Step 110 and/or as filtered in Step 140, desirability of scheduling the new appointment to the time interval may be estimated according to each of the criteria in the set obtained in Step 105, optionally as filtered in Step 140.

On Step 152, a determination whether a criterion to be estimated is indicated as an individual criterion may be made. If yes, then Steps 154 to 158 may be performed. Otherwise, the criterion may be applied and Step 152 may be repeated for each of the remaining criteria to be estimated, if any, or the method may proceed to Step 160.

On Step 154, a set of technicians assigned to appointments scheduled to the time interval may be filtered based on a technician profile. The technician profile may be associated with a specific individual criterion or defined globally for all individual criteria. The assignment of technicians to scheduled appointments, i.e. appointments for which a time window has already been selected, may be obtained by solving the workforce scheduling problem induced thereby.

On Step 156, the individual criterion may be estimated for each technician individually.

On Step 158, the individual values obtained in Step 156 may be merged into a consolidated estimation of the individual criterion. The merging of individual values may be performed according to predetermined scheme. In some exemplary embodiments, the consolidated estimation may be computed using the formula:

E(Cᵢ)=(1−β)*(V₁+V₂*β+V₃*β²+ . . . )

where V₁, V₂, . . . are the individual estimations taken in descending order, and β is some value smaller than one, e.g. 0.9 or the like.

On Step 160, the criteria estimations obtained in Step 150 may be normalized. In some exemplary embodiments, the normalization may be performed using the formula:

$$E ( {t}_{i} ) = \frac{4}{π} {tan}^{- 1} ( \frac{{x}_{i}}{α} )$$

where t₁, . . . tₖ are the time intervals considered, x₁, . . . xₖ are the estimations of those time intervals according to a given criterion Cⱼ, tan⁻¹( ) is the inverse tangent trigonometric function and

$$α = {( {x}_{1} * … * {x}_{k} )}^{\frac{1}{k}} .$$

The estimation E (tᵢ) thereby obtained is in the range [0,2], where the closer the value is to 2 the higher desirability is attributed to the time interval and vice versa. It will be appreciated that in case the estimation obtained in Step 150 is already in the range of [0,2] then the normalization may be skipped.

On Step 170, the criteria estimations, optionally as normalized in Step 160, may be amplified by the assigned priorities. The amplification may be performed according to a predetermined scheme, such as, for example, by addition, multiplication, exponentiation, i.e. raising to a power, or the like.

On Step 180, a balanced score for each time interval may be calculated using the criteria estimations, optionally as amplified in Step 170. The criteria estimations may be aggregated into a balanced score according to predetermined scheme, such as summation, product, or the like. In some exemplary embodiments, the balanced score, i.e. overall rating of a given time interval based on the given criteria, may be calculated using the formula:

E(tᵢ)=E(C₁)^{Pr(C}^{₁}⁾*E(C₂)^{Pr(C}^{₂}⁾* . . . *E(Cₘ)^{Pr(C}^{ₘ})

where C₁, C₂, . . . Cₘ are the criteria, E(Cᵢ) is the normalized estimation for criterion Cᵢ, and Pr(Cᵢ) is the assigned priority.

On Step 190, one or more time slots may be selected based on the balanced scores computed on Step 180, by selecting those time slots having the best balanced scores, e.g. of the highest values.

Referring now to FIG. 2 showing an apparatus in accordance with some exemplary embodiments of the disclosed subject matter. An Apparatus 200 may be configured to select time windows for vehicle routing problem, in accordance with the io disclosed subject matter. In some exemplary embodiments, Apparatus 200 may comprise one or more Processor(s) 202. Processor 202 may be a Central Processing Unit (CPU), a microprocessor, an electronic circuit, an Integrated Circuit (IC) or the like. Processor 202 may be utilized to perform computations required by Apparatus 200 or any of it subcomponents.

In some exemplary embodiments of the disclosed subject matter, Apparatus 200 may comprise an Input/Output (I/O) module 205. I/O Module 205 may be utilized to provide an output to and receive input from a user, such as define rules and criteria for opening time slots, assign priorities to criteria, specify appointment and/or technician profiles, receive new appointment requests, review selected time windows, or the like.

In some exemplary embodiments, Apparatus 200 may comprise Memory 207. Memory 207 may be a hard disk drive, a Flash disk, a Random Access Memory (RAM), a memory chip, or the like. In some exemplary embodiments, Memory 207 may retain program code operative to cause Processor 202 to perform acts associated with any of the subcomponents of Apparatus 200.

Criteria Estimation Module 210 may be configured to estimate desirability of scheduling a new appointment to a time interval according to a defined criterion, similarly as in Step 150 of FIG. 1A. Criteria Estimation Module 210 may be configured to apply the criterion on the time interval to obtain a score value. In some exemplary embodiments, Criteria Estimation Module 210 may be configured to obtain an indication that the criterion is an individual one, similarly as in Step 152 of FIG. 1A, and, in response, to apply the criterion with respect to individual technicians and to merge the individual values into a consolidated estimation, similarly as in Steps 156 to 158 of FIG. 1B.

Profile Filtering Module 220 may be configured to filter a set of criteria and/or a set of candidate time slots based on an appointment profile, similarly as in Step 140 of FIG. 1A. In some exemplary embodiments, Profile Filtering Module 220 may be configured to filter a set of technicians based on a technician profile, similarly as in Step 154 of FIG. 1B. Profile Filtering Module 220 may be utilized by Criteria Estimation Module 210 to determine whether estimating a criterion may be skipped for certain time intervals or altogether, and/or whether estimation of an individual criterion may be skipped for certain technicians.

Criteria Balancing Module 230 may be configured to calculate a balanced score representing the goodness of fit of a candidate time interval for scheduling a new appointment according to a set of criteria, similarly as in Step 180 of FIG. 1B. Criteria Balancing Module 230 may be configured to aggregate a plurality of criteria scores for the time interval, such as obtained by Criteria Estimation Module 210 for each of the criteria, according to predetermined scheme. In some exemplary embodiments, Criteria Balancing Module 230 may be further configured to normalize the criteria estimations prior to aggregation, similarly as in Step 160 of FIG. 1B. Additionally or alternatively, Criteria Balancing Module 230 may be configured to amplify the criteria estimations by priorities assigned thereto, similarly as in Step 170 of FIG. 1B.

Time Window Selector 240 may be configured to select a time window for scheduling a new appointment received based on the balanced score calculated by Criteria Balancing Module 230 for each of a plurality of available time intervals, similarly as in Step 190 of FIG. 1B.

Scheduling Problem Solver 250 may be configured to assign technicians to appointments already scheduled to the candidate time intervals. Scheduling Problem Solver 250 may be utilized by Criteria Estimation Module 210 in applying criteria that depend on the solution to the scheduling problem induced by the previously scheduled appointments, such as some individual criteria might be.

Candidates Updater 260 may be configured to obtain and/or update a current working set of candidate time intervals for scheduling new appointments therein, e.g. based on a time horizon parameter specified. In some exemplary embodiments, Candidates Updater 260 may utilize Profile Filtering Module 220 to filter the set of available time intervals prior to employing Criteria Estimation Module 210.

### Embodiment

Let t₁, t₂, . . . , tₖ be a set of available time windows, and A₁, A₂, . . . , Aₙ₋₁ a set of appointments, where for each appointment Aᵢ its location, duration and set of required skills to accomplish the task at hand are specified, i.e. Aᵢ={Locᵢ, Durᵢ, Skillsᵢ}. For each appointment Aᵢ there is a time window T(Aᵢ) ∈ {t₁, . . . tₖ} which defines when the appointment will be accomplished by the technician. Each technician route starts and ends at a base station B at a known location.

Problem definition: for each new arrived appointment Aₙ, determine an optimal time window T (Aₙ) in {t₁, . . . , tₖ}. It will be noted that {t₁, . . . , tₖ} may be defined as the subset of valid time intervals along a predefined time horizon from Tₛₜₐᵣₜ to T_{end}, updated periodically or on demand by removal of the earlier part preceding current time and extending the remainder as appropriate.

In one embodiment, the disclosed subject matter may implement one or more of the following exemplary algorithmic criteria:
“Closeness”. This criterion enforces selection of a time slot wherein there are appointments which are close to the location of the new appointment. It may be calculated as follows:
   Let A₁, . . . , Aₛ be approved appointments in time interval tᵢ, and Aₓ the new appointment. Let D₀ and D₁, . . . , Dₛ be the distances from the locations of the base B and A₁, . . . Aₛ to the location of Aₓ, respectively. Let Cⱼ denote the criterion.
Set the estimation as:

$$E ( {C}_{j} ) = ( 1 - β ) * ( \frac{F}{{D}_{{a}_{0}}} + \frac{F}{{D}_{{a}_{1}}} * β + \frac{F}{{D}_{{a}_{2}}} * {β}^{2} + … ) ,$$

where F is a unit calibration parameter, Dₐ_{₀}, Dₐ_{₁}, . . . , Dₐ_{ₛ} denotes re-indexing of D₀, D₁, . . . , Dₛ in descending order, and β ∈ (0, 1], e.g. β=0.8.
“ThrowBase”. This criterion enforces selection of the slots wherein the new appointment can be located on the way from base to one of the existing appointments. It may be calculated as follows:
   Let D (B, Aᵢ) be the distance between the locations of the base B and appointment Aᵢ , and D(Aᵢ,Aⱼ) the distance between the locations of appointments Aᵢ and Aⱼ.
   For each approved appointment Aᵢ, set:

$$S ( {A}_{i} ) = 2 * \frac{max \{ D ( B , {A}_{i} ) , D ( B , {A}_{x} ) \}}{min \{ D ( B , {A}_{i} ) + D ( {A}_{i} , {A}_{x} ) , D ( B , {A}_{x} ) + D ( {A}_{x} , {A}_{i} ) \}}$$

where Aₓ is the new appointment.
Set the estimation as:

E(Cⱼ)=(1−β)*(S(Aₐ_{₁})+S(Aₐ_{₂})*β+S(Aₐ_{ₛ})*β²+ . . . )

where S(Aₐ_{₁}), . . . , S(Aₐ_{ₛ}) denotes re-indexing of S(A₁), . . . , S(Aₛ) in descending order.
“Insertion in period”. This criterion favors intervals wherein the new appointment may be inserted to a potential round trip in an optimal manner It may be calculated as follows:
   Let A₁, . . . , Aₛ be approved appointments in time interval tᵢ, and Aₓ the new appointment. Let Aₐ_{₁}, . . . , Aₐ_{ₛ} be a re-ordering of A₁, . . . , Aₛ such that the length of the path from base B to the location of Aₐ_{₁}, then to the location of Aₐ_{₂}, and so forth up until the location of Aₐ_{ₛ} , and then back to base B, is minimized
   For each consequent pair of appointments (Aₐ_{_{i−1}}, Aₐ_{ᵢ}), i ∈ {1, . . . , s}, where Aₐ_{₀} denotes the base B, calculate a value H(i) as:

$$H ( i ) = 2 * \frac{D ( {A}_{{a}_{i - 1}} , {A}_{{a}_{i}} )}{D ( {A}_{{a}_{i - 1}} , {A}_{x} ) + D ( {A}_{{a}_{i}} , {A}_{x} )} ,$$

where D(Aᵢ, Aⱼ) denotes the distance between the locations of Aᵢ and Aⱼ.
Set the estimation as:

E(Cⱼ)=(1−β)*(Hₐ_{₁}+Hₐ_{₂}*β+Hₐ_{₃}*β²+ . . . )
where Hₐ_{₁}, . . . , Hₐ_{ₛ} denote re-indexing of the values H(1), . . . , H(s) in descending order.
“Balance”. This criterion enforces selection of time windows which are less utilized. It may be calculated as follows:
   Denote by W(Aᵢ) the duration of an appointment Aₗ.
   Set the estimation as:

$$E ( {C}_{j} ) = \frac{1}{w + {\sum }_{i} W ( {A}_{i} )} ,$$

where the summation is over all approved appointments Aᵢ at the time interval in question, and w is some average working interval calibration parameter.
“Best traveling salesman” This is an individual criterion. It may be calculated as follows:
   Let A₁, . . . , Aₑ be approved appointments at a given time interval, and assigned to a given technician. Denote by P_{old} the overall traveling distance of an optimal round trip covering all these appointments, e.g. of minimized length. Denote by P_{new} the length of an optimal path that further includes the newly arrived appointment.
   Set the individual estimation for each technician as:

$$2 * \frac{{P}_{old}}{{P}_{new}}$$

“Weekly history”. This criterion assumes similar distributions of service requests. It may be implemented as follows:
   Let Aₓ be a new appointment.
   For each of the days in the previous week, calculate the number of appointments with properties similar to Aₓ, e.g. appointments originating from the same area location or the like.
   Set the estimation to be highest for intervals on the same day of the week in which most of the similar appointments were found.
“Random”. This criterion simply chooses at random one of the time intervals in the set. It may be implemented by sampling the set of time intervals according to a uniform distribution or the like.

It will be appreciated that the exemplary algorithmic criteria illustrated above may be extended accordingly to be applied also in multi-site instances of VRPs where multiple bases {B₁, . . . , Bₙ} from which technicians are dispatched, and to which they return after completion of the assigned tasks, may be defined. The following exemplary modifications may be introduced for this purpose as follows:
“Closeness”. This criterion may be calculated similarly as above, where for base B one may choose the closest base Bᵢ ∈ {B₁, . . . , Bₙ} to the new appointment Aₓ which has resources to serve it, i.e. technicians with required skills set, available time shifts, and/or the like.
“Throw Base”. This criterion may be calculated similarly as above, where for each previously approved appointment Aᵢ, it may be assumed that for the role of base B, the closest base Bᵢ ∈ {B₁, . . . , Bₙ} is chosen.
“Insertion in Period”. This criterion may be calculated similarly as above, where base may be skipped and where only approved appointments for the period at hand may be taken into account.
“Best traveling salesman”. This criterion may be calculated similarly as above, where it may be assumed that for each technician only one base, i.e. associated depot exists.
   It will be appreciated that other algorithmic criteria discussed above, such as “Balance”, “Weekly history” and “Random”, for example, may be calculated in the same manner as above without modification.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non- exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field- programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
obtaining a set of criteria for estimating desirability of scheduling an appointment to a time interval;
obtaining a set of time intervals at which appointments can be scheduled;
receiving a new appointment for scheduling to a time interval;
calculating, for each time interval of the set, a balanced score according to the set of criteria; and
selecting, based on the balanced score, a time interval for scheduling the new appointment.

2. The computer-implemented method of claim 1, wherein said calculating comprising:
applying each of the criteria on the time interval to obtain a plurality of criteria scores; and
aggregating the plurality of criteria scores to obtain the balanced score.

3. The computer-implemented method of claim 2, further comprising normalizing the plurality of criteria scores.

4. The computer-implemented method of claim 2, further comprising obtaining priorities assigned for the criteria, wherein the aggregated criteria scores are weighted according to the priorities.

5. The computer-implemented method of claim 2, further comprising:
obtaining a set of technicians to which appointments can be assigned;
obtaining an indication of at least one individual criterion in the set of criteria; and
obtaining criteria scores for the at least one individual criterion by applying the individual criterion with respect to each technician of the set of technicians individually to obtain a plurality of individual scores and merging the plurality of individual scores.

6. The computer-implemented method of claim 5, further comprising obtaining a technician profile, wherein applying the individual criterion is performed selectively based on a technician fitting the technician profile.

7. The computer-implemented method of claim 5, further comprising obtaining a set of appointments scheduled to time intervals of the set and assignment of the scheduled appointments to technicians; wherein the individual criterion is based on one or more parameters of the scheduled appointments assigned to a technician.

8. The computer-implemented method of claim 2, further comprising obtaining an appointment profile, wherein said applying is performed selectively based on the new appointment fitting the appointment profile.

9. The computer-implemented method of claim 1, further comprising obtaining a set of appointments scheduled to time intervals of the set; wherein at least one of the criteria is based on one or more parameters of the scheduled appointments.

10. A computerized apparatus having a processor, the processor being adapted to perform the steps of:
obtaining a set of criteria for estimating desirability of scheduling an appointment to a time interval;
obtaining a set of time intervals at which appointments can be scheduled;
receiving a new appointment for scheduling to a time interval;
calculating, for each time interval of the set, a balanced score according to the set of criteria; and
selecting, based on the balanced score, a time interval for scheduling the new appointment.

11. The computerized apparatus of claim 10, wherein said processor is further adapted to calculate the balanced score by performing the steps of:
applying each of the criteria on the time interval to obtain a plurality of criteria scores; and
aggregating the plurality of criteria scores to obtain the balanced score.

12. The computerized apparatus of claim 11, wherein said processor is further adapted to normalize the plurality of criteria scores.

13. The computerized apparatus of claim 11, wherein said processor is further adapted to obtain priorities assigned for the criteria, wherein the aggregated criteria scores are weighted according to the priorities.

14. The computerized apparatus of claim 11, wherein said processor is further adapted to perform the steps of:
obtaining a set of technicians to which appointments can be assigned;
obtaining an indication of at least one individual criterion in the set of criteria; and
obtaining criteria scores for the at least one individual criterion by applying the individual criterion with respect to each technician of the set of technicians individually to obtain a plurality of individual scores and merging the plurality of individual scores.

15. The computerized apparatus of claim 14, wherein said processor is further adapted to obtain a technician profile, and to apply the individual criterion selectively based on a technician fitting the technician profile.

16. The computerized apparatus of claim 14, wherein said processor is further adapted to obtain a set of appointments scheduled to time intervals of the set and assignment of the scheduled appointments to technicians; wherein the individual criterion is based on one or more parameters of the scheduled appointments assigned to a technician.

17. The computerized apparatus of claim 11, wherein said processor is further adapted to obtain an appointment profile, and to apply the criteria selectively based on the new appointment fitting the appointment profile.

18. The computerized apparatus of claim 10, wherein said processor is further adapted to obtain a set of appointments scheduled to time intervals of the set; wherein at least one of the criteria is based on one or more parameters of the scheduled appointments.

19. A computer program product comprising a non-transitory computer readable storage medium retaining program instructions, which program instructions when read by a processor, cause the processor to perform a method comprising:
obtaining a set of criteria for estimating desirability of scheduling an appointment to a time interval;
obtaining a set of time intervals at which appointments can be scheduled;
receiving a new appointment for scheduling to a time interval;
calculating, for each time interval of the set, a balanced score according to the set of criteria; and
selecting, based on the balanced score, a time interval for scheduling the new appointment.
